(19) United States
(12) Patent Application Publication
(10) Pub. No.: US 2014/0284883 A1
(43) Pub. Date: Sep. 25, 2014

(54) System, Method and Apparatus for Lip Seal Assembly

(71) Applicant: Saint-Gobain Performance Plastics Corporation, Aurora, OH (US)

(72) Inventors: Jan Kustermans, Kontich (BE); Herman Dubois, Kontich (BE); Roel Maes, Kontich (BE); Kris Van Gils, Kontich (BE); Gino Stevenheydens, Kontich (BE); Wim Vandenheuvel, Kontich (BE)

(73) Assignee: Saint-Gobain Performance Plastics Corporation, Aurora, OH (US)

(21) Appl. No.: 14/219,698

(22) Filed: Mar. 19, 2014

Related U.S. Application Data
(60) Provisional application No. 61/804,494, filed on Mar. 22, 2013.

(51) Int. Cl. F16J 15/32

(52) U.S. Cl. CPC F16J 15/3204
USPC 277/572

(57) ABSTRACT

A seal assembly includes a lip seal having an axis, a central opening and a radial extension extending radially inward. The radial extension may be adapted to apply a sealing force against a shaft extending through the central opening by bending. The radial extension may extend at least partially along an axial direction. A support member that is resilient may be positioned adjacent the radial extension such that the support member limits bending of the radial extension.

### CROSS-REFERENCE TO RELATED APPLICATION

The present application claims priority to and the benefit of U.S. Provisional Patent Application No. 61/804,494, filed Mar. 22, 2013, entitled “SYSTEM, METHOD AND APPARATUS FOR LIP SEAL ASSEMBLY”, naming as inventors Jan Kustermans, Herman Dubois, Rod Maes, Kris Van Gils, Gino Stevenheydens and Wim Vandenheuvel, which application is incorporated by reference herein in its entirety.

### FIELD OF THE DISCLOSURE

The present invention relates in general to lip seals and, in particular, to a system, method and apparatus for a lip seal assembly.

### DESCRIPTION OF THE RELATED ART

Various industries are increasingly turning to large-scale equipment to meet operational demands. As industry develops large-scale equipment, it seeks large-scale components, such as seals. The large-scale equipment can be located in remote harsh environments, increasing demand for durable and hardy seals. For example, the power generation industry is employing ever larger equipment. The oil and gas industry also seeks to drill in deeper water, such that the scale of the equipment used is increasing. As a result, the demand for more durable, large-scale products that can survive harsh environments increases. Thus, continued improvements in large scale seals continue to be of interest.

### SUMMARY

Embodiments of a system, method and apparatus for a seal assembly are disclosed. For example, a seal assembly may include a lip seal having an axis, a central opening and a radial extension extending radially inward. The radial extension may be adapted to apply a sealing force against a shaft extending through the central opening by bending. The radial extension may extend at least partially along an axial direction. A support member that is resilient may be configured to be positioned adjacent the radial extension such that the support member limits bending of the radial extension.

Other embodiments of a seal assembly may include a housing. A lip seal having a first lip seal portion may be mounted to the housing. A second lip seal portion may extend from the first lip seal portion and the housing. A support member may extend from the housing into contact with the second lip seal portion. The support member may be configured to engage the second lip seal portion with a shaft.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is sectional side view of an embodiment of a seal assembly deployed on a shaft.

FIG. 2 is an enlarged sectional side view of a portion of an embodiment of a seal assembly deployed on a shaft.

FIG. 3 is a front view of an embodiment of a lip seal for a seal assembly.

FIG. 4 is a sectional side view of another embodiment of a seal assembly.

FIGS. 5A-5C are front, partial sectional and enlarged sectional views, respectively, of still another embodiment of a seal assembly.

FIGS. 6A-6C are front, partial sectional and enlarged sectional views, respectively, of still another embodiment of a seal assembly.

The use of the same reference symbols in different drawings indicates similar or identical items.

### DETAILED DESCRIPTION

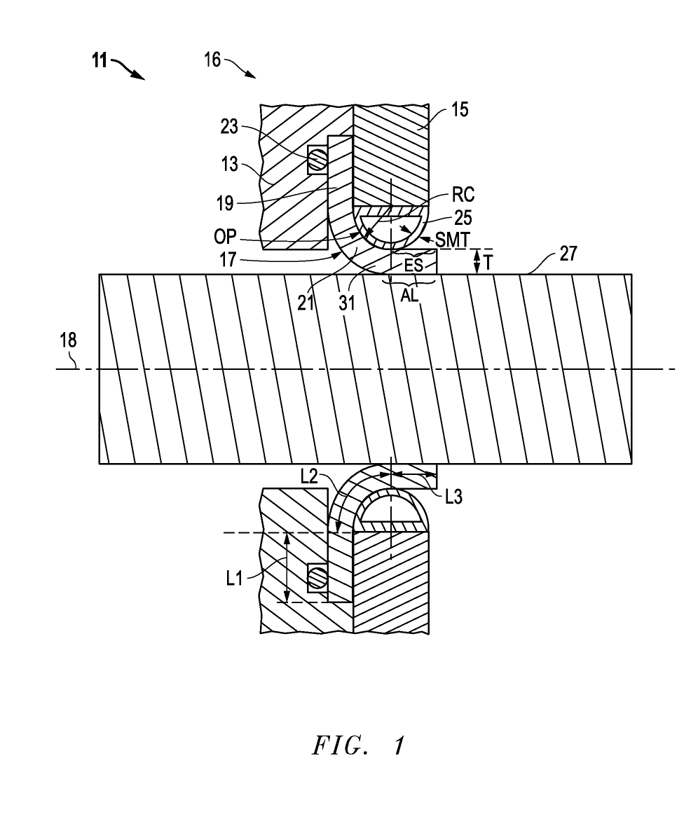

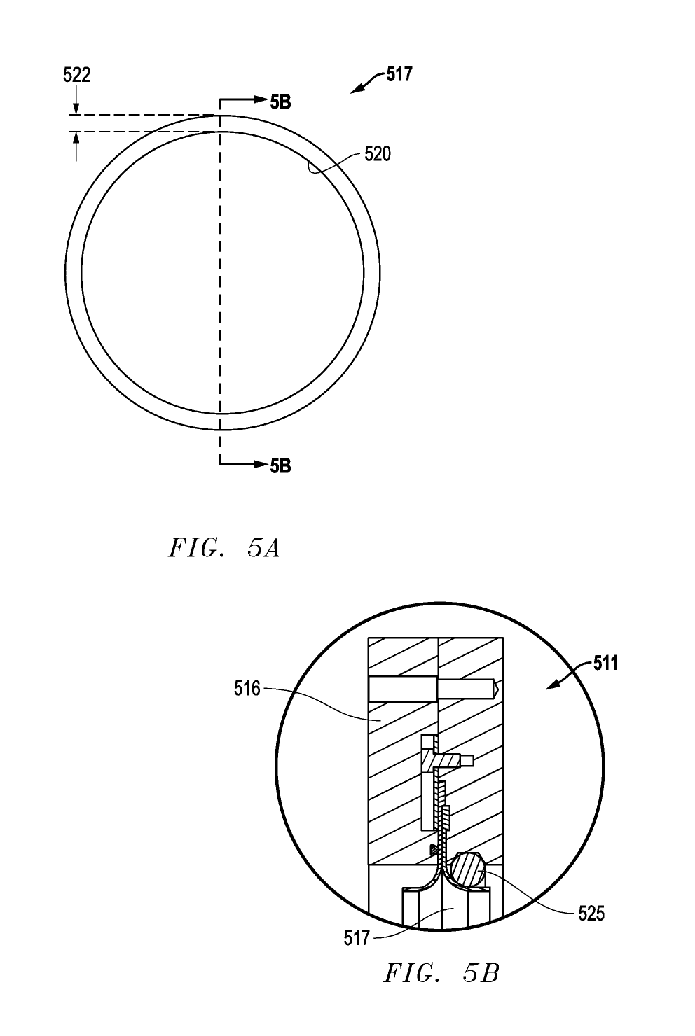

Embodiments of a system, method and apparatus for a seal assembly are disclosed. In the examples of FIGS. 1-4, a seal assembly 11 may comprise an annular lip seal 17 having an axis 18. The lip seal 17 may include a central opening 20 (FIG. 3) and a radial extension 22 extending radially inward. The radial extension 22 may be flexible and comprise a flexible material. The radial extension 22 may be adapted to apply a sealing force against a shaft 27 extending through the central opening 20 by bending. The radial extension 22 may extend at least partially along an axial direction.

The seal assembly 11 may further comprise a support member 25 that is resilient and configured to be positioned adjacent the radial extension 22 such that the support member 25 limits bending of the radial extension 22. The support member 25 may be configured to be positioned at least one of axially and radially adjacent the radial extension 22 upon disposition of the shaft 27, such that at least one of an axial force and a radial force are applied to the radial extension 22. The support member 25 may be configured to help maintain a desired profile for lip seal 17, which may enhance the force, pressure and sealing to shaft 27, as well as prevent unwanted deformation of lip seal 17.

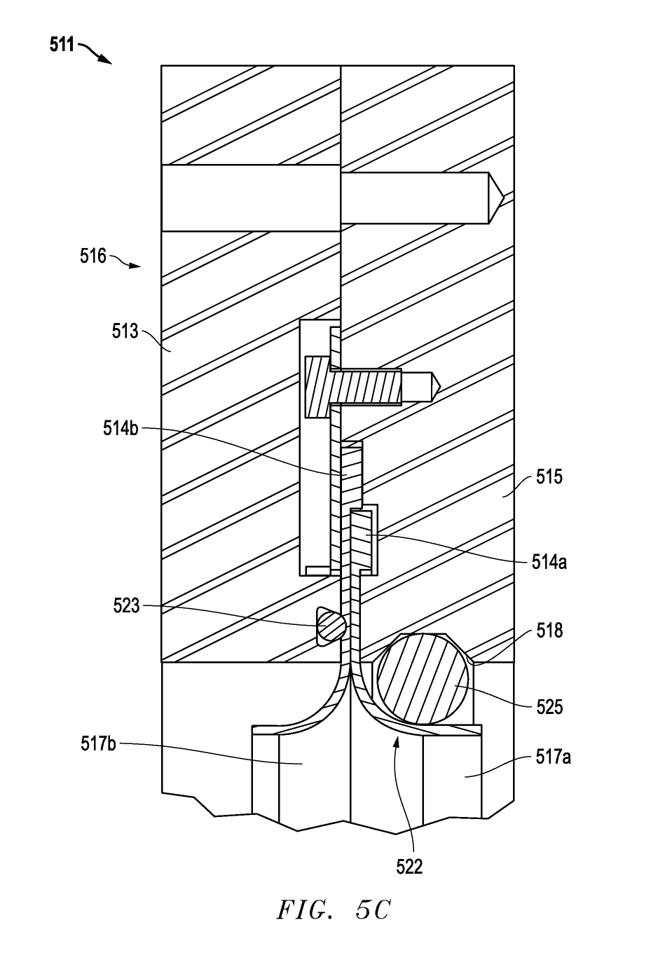

In some embodiments, the support member 25 may comprise a taper 26 (FIG. 4), such as a linear taper. Likewise, the radial extension 22 also may comprise a taper 28, such as a linear taper. These tapers 26, 28 may be provided in the support member 25 and radial extension 22, such that they are present in those components even when the components are not yet deployed or installed on the shaft 27 (i.e., the tapers may be present in the components in their nominal or undeployed states).

Embodiments of the seal assembly 11 also may comprise a housing 16. The housing 16 may comprise one or more components. For example, the housing 16 may comprise an outer housing 13 and an inner housing 15. The lip seal 17 may be mounted to the housing 16, such as being located between the outer and inner housings 13, 15. The inner housing 15 may be mountable to the outer housing 13, or vice-versa. Alternatively, the housing 16 may comprise a single component that captures or grips a portion of the lip seal, such as by crimping. Also, embodiments of the support member 25 may be bonded, mechanically joined or welded to the housing 16, or any combination thereof.

Some embodiments of the support member 25 may be provided with a thickness (SMT) of about 0.1 mm to about 20 mm, depending on the material selected for the support member. The SMT may be at least one of uniform and symmetric, or the SMT may be at least one or non-uniform and asymmetric. In some versions, the SMT can be at least about 0.1 mm, such as at least about 1 mm, at least about 5 mm, or even at least about 10 mm, and/or not greater than about 20 mm, such as not greater than about 15 mm, or even not greater than about 12 mm. The SMT also may be in a range between any of these minimum and maximum values. If the support member comprises metal spring elements, the SMT can be thinner than that of elastomer support members.

Embodiments of the support member 25 may contact the second lip seal portion 21 over an angular span of at least about 10 degrees, such as at least about 20 degrees, at least about 30 degrees, at least about 40 degrees, or even at least about 50 degrees. In some versions, the angular span is not greater than about 100 degrees, such as not greater than about 90 degrees, not greater than about 80 degrees, or even not greater than about 70 degrees. The angular span also may be provided in range between any of these minimum and maximum values.

Some embodiments of the support member 25 may comprise an elastomer (e.g., silicone, rubber, plastic, etc.), a metal spring element, or a combination thereof. The support member 25 may comprise a shock absorber. Versions of the support member 25 may be hollow or solid. The support member 25 may be formed from a single component. In the illustrated embodiment, the support member 25 may be annular and may have a D-shaped sectional profile, including a flat outer portion mounted to the inner housing 15.

Embodiments of the support member 25 that comprise an elastomer can have a hardness in a variety of ranges, such as Shore A, Shore D, or Shore OO. For example, the support member can have a Shore A hardness of at least about 5, such as at least about 10, at least about 20, at least about 30, at least about 40, at least about 50, at least about 60, at least about 70, or even at least about 80, and/or not greater than about 100, such as not greater than about 90, not greater than about 80, or even not greater than about 70. The hardness also may be provided in range between any of these minimum and maximum values.

In another version, the support member can have a Shore D hardness of at least about 5, such as at least about 10, at least about 20, at least about 30, at least about 40, at least about 50, at least about 60, at least about 70, or even at least about 80, and/or not greater than about 100, such as not greater than about 90, not greater than about 80, or even not greater than about 70. The hardness also may be provided in range between any of these minimum and maximum values.

Alternatively, the support member can have a Shore OO hardness of at least about 5, such as at least about 10, at least about 20, at least about 30, at least about 40, at least about 50, at least about 60, at least about 70, or even at least about 80, and/or not greater than about 100, such as not greater than about 90, not greater than about 80, or even not greater than about 70. The hardness also may be provided in range between any of these minimum and maximum values.

Embodiments of the support member 25 that comprise a metallic material can have a hardness in a variety of ranges, such as Vickers hardness. For example, the support member can have a Vickers hardness of at least about 50, such as at least about 100, at least about 200, at least about 500, at least about 750, at least about 1000, at least about 1250, or even at least about 1500, and/or not greater than about 2000, such as not greater than about 1900, not greater than about 1800, or even not greater than about 1700. The hardness also may be provided in range between any of these minimum and maximum values.

Some embodiments of the support member 25 may be provided with a spring constant, such as about 0.1 N/m up to about 100,000 N/m, depending on the material selected. For example, the support member may have a spring constant of at least about 0.1 N/m, such as at least about 1 N/m, at least about 10 N/m, at least about 100 N/m, at least about 1000 N/m, or even at least about 10,000 N/m, and/or not greater than about 100,000 N/m, not greater than about 10,000 N/m, not greater than about 1000 N/m, not greater than about 100 N/m, or even not greater than about 10 N/m. The spring constant also may be provided in range between any of these minimum and maximum values.

Embodiments of the support member 25 may be provided with a density in a range of about 10 kg/m³ to about 9000 kg/m³, depending on the material selected. For example, the support member may be provided with a density of at least about 10 kg/m³, such as at least about 100 kg/m³, at least about 1000 kg/m³, or even at least about 5000 kg/m³, and/or not greater than about 9000 kg/m³, such as not greater than about 9000 kg/m³, not greater than about 5000 kg/m³, not greater than about 1000 kg/m³, or even not greater than about 100 kg/m³. The density also may be provided in range between any of these minimum and maximum values.

Some embodiments of the lip seal 17 may comprise a first lip seal portion 19 and a second lip seal portion 21. The first lip seal portion 19 may be mounted to the housing 16, and the second lip seal portion 21 may extend therefrom. In some versions the lip seal 17 further comprises a third lip seal portion 31 configured to contact the shaft 27. The support member 25 may be in contact with the first, second and third lip seal portions 19, 21, 31. The lip seal 17 may comprise one or more of a variety of materials, such as a fluorinated polymer (e.g., polytetrafluoroethylene (PTFE)), polyethylene or a mixture or copolymer thereof.

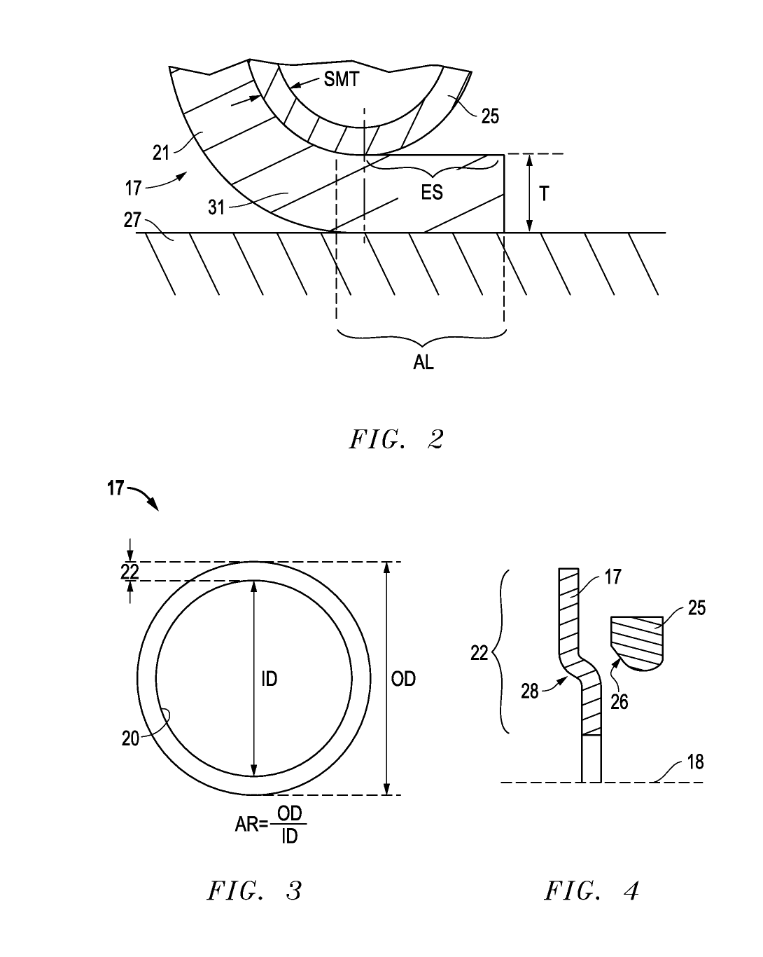

Embodiments of the first lip seal portion 19 may extend exclusively in a radial direction. Versions of the third lip seal portion 31 may extend exclusively in an axial direction. The second lip seal portion 21 may extend between the first and third lip seal portions 19, 31. In some embodiments, an end segment (ES) (FIG. 2) of the third lip seal portion 31 may be configured to contact only the shaft 17, such that the ES is free of contact with the support member 25.

In some embodiments (FIG. 1), the first lip seal portion 19 may be provided with a length (L1), the second lip seal portion 21 may be provided with a length (L2), and the third lip seal portion 31 may be provided with a length (L3). A ratio of L2/L3 may be expressed as at least about 1, such as at least about 1.1, at least about 1.2, at least about 1.3, at least about 1.4, or even at least about 1.5. In other embodiments, the ratio L2/L3 may be not greater than about 5, such as not greater than about 4, not greater than about 3, or even not greater than about 2. The ratio L2/L3 also may be provided in range between any of these minimum and maximum values.

Embodiments of the support member 25 may extend from the housing 16 into contact with the second lip seal portion 21. The support member 25 may be configured to engage the second lip seal portion 21 with the shaft 27. The support member 25 may be configured to be spaced apart from the shaft 27 only by a thickness (T) (FIG. 2) of the lip seal 17 upon disposition of the shaft 27. In some versions, there is no gap between the support member 25 and the second lip seal portion 21 in the radial direction. In other embodiments, there may be no gaps between the support member 25 and one or more of the first, second and third lip seal portions 19, 21, 31.

In still other embodiments (e.g., FIG. 3), the lip seal 17 may be configured with a flat, undeflected configuration prior to installation with an inner diameter (ID) of at least about 20 cm, and not greater than about 500 cm, not greater than about 400 cm, or not greater than about 300 cm. Such versions of the seal assembly 11 may be configured to seal shafts 27 having a shaft outer diameter of at least about 20 cm, and not greater than about 500 cm, such as not greater than about 400 cm, or even not greater than about 300 cm.

Embodiments of the lip seal 17 may comprise an aspect ratio (AR)=outer diameter (OD)/inner diameter (ID) of less than about 1.15, such as less than about 1.12, less than about 1.09, less than about 1.06, less than about 1.03, or at least about 1.01. The aspect ratio AR also may be provided in range between any of these minimum and maximum values.

Some versions of the seal assembly 11 may be provided with a mass of about 10 kg to about 200 kg. The seal assembly 11 may further comprise a second seal member 23. Embodiments of the second seal member 23 may be located between the outer housing 13 and the lip seal 17. For example, the second seal member 23 may comprise an o-ring or a gasket.

Embodiments of the seal assembly 11 may be configured to seal selected shaft rotational speeds. For example, the shaft rotational speed may be greater than 0 m/s, such as at least about 10 m/s, at least about 20 m/s, at least about 30 m/s, not greater than about 50 m/s, not greater than about 45 m/s, or even not greater than about 40 m/s. The shaft rotational speeds also may be provided in range between any of these minimum and maximum values.

Other embodiments of the seal assembly 11 may be configured to seal the shaft with a seal pressure. For example, the seal pressure may be greater than 0 bar, such as at least about 1 bar, at least about 2 bar, at least about 4 bar, at least about 6 bar, not greater than about 10 bar, or even not greater than about 8 bar. The seal pressure also may be provided in range between any of these minimum and maximum values.

In still other embodiments, the seal assembly 11 may be configured to seal a shaft 27 having an eccentricity of rotation. For example, the shaft eccentricity of rotation may be greater than 0 mm, such as at least about 0.5 mm, at least about 1 mm, at least about 1.5 mm, or even not greater than about 2 mm. The shaft eccentricity of rotation also may be provided in range between any of these minimum and maximum values.

Embodiments of the seal assembly 11 may be configured to contact an outer surface of a shaft 27 having an axis 18. The lip seal 17 may be configured to contact the shaft over an axial length (AL) of at least about 2 mm, such as at least about 2 mm, at least about 2 mm, at least about 2 mm, at least about 2 mm, not greater than about 20 mm, not greater than about 18 mm, not greater than about 16 mm, not greater than about 14 mm, or even not greater than about 12 mm. The axial length of contact also may be provided in range between any of these minimum and maximum values.

Embodiments of the seal assembly 11 may be installed on a shaft 27, such that the lip seal 17 may be configured to stretch. The term “stretch” may be defined as (stretched length in the installed or deployed configuration)/(relaxed length in the uninstalled or undeployed configuration). For example, the amount of stretch may be not greater than about 6%, such as not greater than about 4%, not greater than about 3%, not greater than about 2.5%, not greater than about 2%, at least about 0.5%, at least about 1%, or even at least about 1.5%. The stretch amount also may be provided in range between any of these minimum and maximum values.

As shown in FIG. 1, additional embodiments of the support member 25 may be provided with a profile that defines a radius of curvature (RC) for the second lip seal portion 21. In some versions, the RC is at least one of uniform and symmetric, and in other versions the RC is at least one of non-uniform and asymmetric. For example, the RC may be at least about 2 mm, such as at least about 4 mm, at least about 6 mm, at least about 8 mm, at least about 10 mm, not greater than about 20 mm, not greater than about 18 mm, not greater than about 16 mm, not greater than about 14 mm, or even not greater than about 12 mm. The RC also may be provided in range between any of these minimum and maximum values.

In other examples, one or more of the seal assemblies 11 may be packaged and sold as a kit. For instance, a plurality of the seal assemblies 11 or its components (e.g., just the lip seals 17, or just the support members 25) may be sold or packaged in groups, depending on the application. In addition, embodiments of the seal assembly 11 are much easier and faster to install and/or replace than existing seal assembly designs.

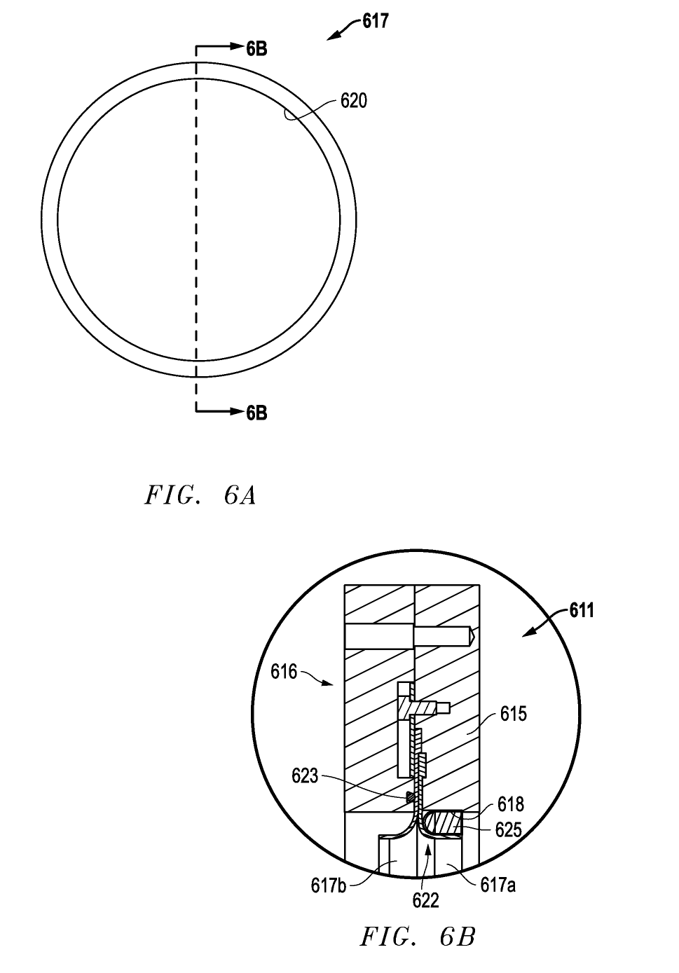

Referring now to FIGS. 5A-5C, still other embodiments of a seal assembly 511 are illustrated. In some versions, the support element 525 may comprise one or more materials, and may comprise a metal component. Such metal components may be welded to the hardware, such as the housing 515. Seal assembly 511 may comprise an annular lip seal 517 having an axis. The lip seal 517 may comprise one or more lip seals, such as the lip seals 517a, 517b depicted. Lip seals 517a, 517b may extend in opposite axial directions as illustrated. The lip seal 517 may include a central opening 520 and a radial extension 522 extending radially inward. The radial extension 522 may be configured as described elsewhere herein for other embodiments. The radial extension 522 may be adapted to apply a sealing force against a shaft extending through the central opening 520 by bending.

The seal assembly 511 may further comprise a support member 525 that is resilient and configured to be positioned adjacent the radial extension 522 such that the support member 525 limits bending of the radial extension 522. The support member 525 may be configured to be positioned at least one of axially and radially adjacent the radial extension 522. For example, FIG. 5C depicts support member 525 only radially adjacent the radial extension 522, but axially spaced apart and free of contact therefrom. Support member 525 may comprise a solid or hollow ring that is circular in cross-sectional shape.

Embodiments of the seal assembly 511 also may comprise a housing 516. The housing 516 may comprise one or more components. For example, the housing 516 may comprise an outer housing 513 and an inner housing 515. The lip seal 517 may be mounted to the housing 516, such as being located between the outer and inner housings 513, 515. In some examples, lip seal 517a is thicker than lip seal 517b. Versions of lip seal 517a may have shorter radial length than that of lip seal 517b. Embodiments of the support member 525 may be bonded, mechanically joined or welded to the housing 16, such as in recess 518, or any combination thereof. In the illustrated example, lip seals 517a, 517b may have enlarged outer portions 514a, 514b, respectively, that may be captured in separate recesses in housing 516.

Other embodiments of seal assembly 511 may be configured as described elsewhere herein for the other embodiments. For example, the seal assembly 511 may comprise the various dimensions, parameters, performance, materials, etc., described herein.

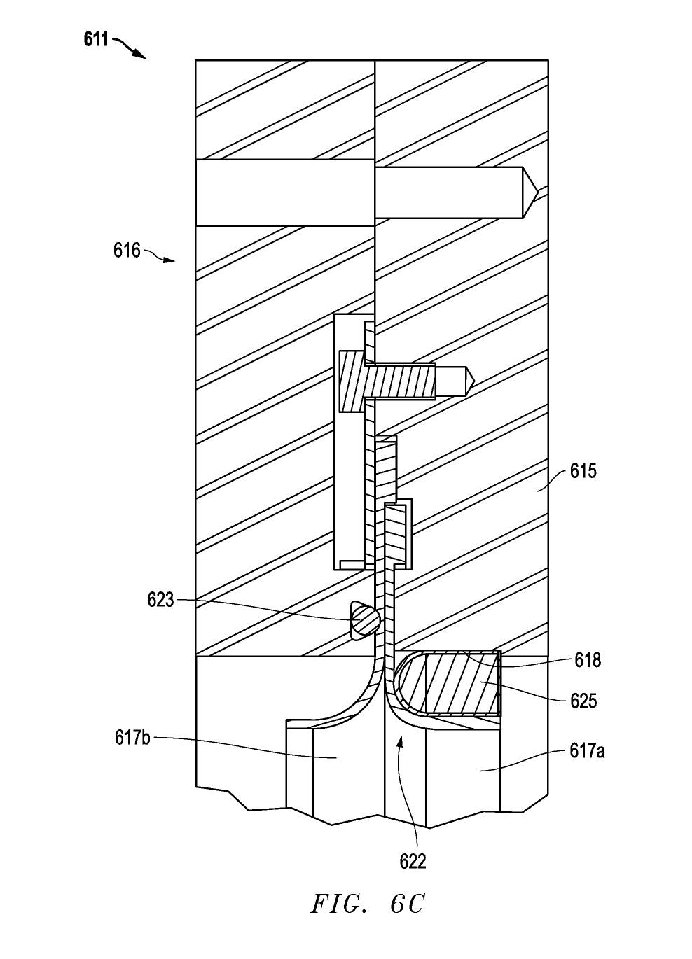

FIGS. 6A-6C illustrate another embodiment of a seal assembly 611. Some versions of seal assembly 611 may be configured in a virtually identical manner as seal assembly 511, other than their respective support members 525, 625. In some embodiments, seal assembly 611 may comprise an annular lip seal 617 having an axis. The lip seal 617 may comprise one or more lip seals, such as lip seals 617a, 617b. The seal assembly 611 may be configured as described elsewhere herein for other embodiments. The seal assembly 611 may further comprise a support member 625 that is resilient and configured to be positioned adjacent the radial extension 622 such that the support member 625 limits bending of the radial extension 622. The support member 625 may be configured to be positioned at least one of axially and radially adjacent the radial extension 622. Support member 625 may comprise a solid or hollow ring, having a variety of cross-sectional shapes, such as the D-shape or bullet shape shown.

Embodiments of the seal assembly 611 also may comprise a housing 616 having one or more components. The lip seal 617 may be mounted to the housing 616. Embodiments of the support member 625 may be bonded, mechanically joined or welded to the housing 16, such as in recess 618. Other embodiments of seal assembly 611 may be configured as described elsewhere herein for the other embodiments. For example, the seal assembly 611 may comprise the various dimensions, parameters, performance, materials, etc., described herein.

Other embodiments may include one or more of the following items:

Item 1. A seal assembly, comprising:

a lip seal that is annular and has an axis, a central opening and a radial extension extending radially inward, the radial extension being flexible and adapted to apply a sealing force against a shaft extending through the central opening by bending, such that the radial extension extends at least partially along an axial direction; and

a support member that is resilient and configured to be positioned adjacent the radial extension such that the support member limits bending of the radial extension.

Item 2. The seal assembly of item 1, wherein the support member is configured to be positioned at least one of axially and radially adjacent the radial extension upon disposition of the shaft, such that at least one of an axial force and a radial force are applied thereto.

Item 3. The seal assembly of item 1, wherein at least one of the lip seal and the support member comprises a taper.

Item 4. The seal assembly of item 3, wherein the taper is linear.

Item 5. The seal assembly of item 1, further comprising a housing, and the lip seal and the support member are adapted to be mounted to the housing.

Item 6. The seal assembly of item 5, wherein the housing comprises an outer housing and an inner housing, and the lip seal is configured to be located between the outer and inner housings.

Item 7. The seal assembly of item 1, wherein the lip seal has a first lip seal portion and a second lip seal portion extending therefrom, and the support member is configured to extend into contact with the second lip seal portion.

Item 8. The seal assembly of item 1, wherein the support member is configured to be spaced apart from the shaft only by a thickness (T) of the lip seal, such that there is no gap between the support member and the second lip seal portion in the radial direction upon disposition of the shaft.

Item 9. The seal assembly of item 1, wherein the support member has a thickness (SMT) of at least about 0.1 mm, at least about 1 mm, at least about 5 mm, at least about 10 mm, and not greater than about 20 mm, not greater than about 15 mm, not greater than about 12 mm.

Item 10. The seal assembly of item 9, wherein the SMT is at least one of uniform and symmetric.

Item 11. The seal assembly of item 9, wherein the SMT is at least one of non-uniform and asymmetric.

Item 12. The seal assembly of item 1, wherein the support member is configured to contact the lip seal over an angular span of at least about 10 degrees, at least about 20 degrees, at least about 30 degrees, at least about 40 degrees, at least about 50 degrees, not greater than about 100 degrees, not greater than about 90 degrees, not greater than about 80 degrees, not greater than about 70 degrees.

Item 13. The seal assembly of item 1, wherein the lip seal comprises a first lip seal portion that is configured to extend exclusively in a radial direction, a third lip seal portion that is configured to extend exclusively in an axial direction in contact with the shaft, and a second lip seal portion that extends between the first and third lip seal portions.

Item 14. The seal assembly of item 13, wherein the second lip seal portion has a length (L2) and the third lip seal portion has a length (L3), and a ratio of L2/L3 is at least about 1, at least about 1.1, at least about 1.2, at least about 1.3, at least about 1.4, at least about 1.5, not greater than about 5, not greater than about 4, not greater than about 3, not greater than about 2.

Item 15. The seal assembly of item 1, wherein an end segment (ES) of the lip seal is configured to contact only the shaft and is free of contact with the support member.

Item 16. The seal assembly of item 1, wherein the support member comprises at least one of an elastomer or a metal spring element.

Item 17. The seal assembly of item 1, wherein the support member is a shock absorber.

Item 18. The seal assembly of item 1, wherein the support member is hollow.

Item 19. The seal assembly of item 1, wherein the support member is solid.

Item 20. The seal assembly of item 1, wherein the support member is formed from a single component.

Item 21. The seal assembly of item 1, wherein the support member is annular and has a D-shaped sectional profile, including a flat outer portion mounted to the housing.

Item 22. The seal assembly of item 1, wherein the support member has a density of at least about 10 kg/m³, at least about 100 kg/m³, at least about 1000 kg/m³, at least about 5000 kg/m³, and not greater than about 9000 kg/m³, not greater than about 9000 kg/m³, not greater than about 5000 kg/m³, not greater than about 1000 kg/m³, not greater than about 100 kg/m³.

Item 23. The seal assembly of item 5, wherein the support member is bonded, mechanically joined or welded to the housing, or any combination thereof.

Item 24. The seal assembly of item 1, wherein the lip seal comprises a fluorinated polymer, polyethylene or a mixture or copolymer thereof.

Item 25. The seal assembly of item 1, wherein the lip seal has a flat, undeflected configuration prior to installation with an inner diameter (ID) of at least about 20 cm, and not greater than about 500 cm, not greater than about 400 cm, or not greater than about 300 cm, such that the seal assembly is configured to seal shafts having a shaft outer diameter of at least about 20 cm, and not greater than about 500 cm, not greater than about 400 cm, or not greater than about 300 cm.

Item 26. The seal assembly of item 1, wherein the lip seal comprises an aspect ratio (AR)=outer diameter (OD)/inner diameter (ID) of less than about 1.15, less than about 1.12, less than about 1.09, less than about 1.06, less than about 1.03, at least about 1.01.

Item 27. The seal assembly of item 1, wherein the seal assembly has a mass of about 10 kg to about 200 kg.

Item 28. The seal assembly of item 1, further comprising a second seal member configured to be mounted between a housing and the lip seal.

Item 29. The seal assembly of item 28, wherein the second seal member comprises an o-ring or a gasket.

Item 30. The seal assembly of item 1, wherein the seal assembly is configured to seal shaft rotational speeds of at least about 10 m/s, at least about 20 m/s, at least about 30 m/s, not greater than about 50 m/s, not greater than about 45 m/s, or not greater than about 40 m/s.

Item 31. The seal assembly of item 1, wherein the seal assembly is configured to seal the shaft with a pressure of at least about 1 bar, at least about 2 bar, at least about 4 bar, at least about 6 bar, not greater than about 10 bar, not greater than about 8 bar.

Item 32. The seal assembly of item 1, wherein the seal assembly is configured to seal an eccentricity of rotation of the shaft of at least about 0.5 mm, at least about 1 mm, at least about 1.5 mm, not greater than about 2 mm.

Item 33. The seal assembly of item 1, wherein the lip seal is configured to contact the shaft over an axial length (AL) of at least about 2 mm, at least about 2 mm, at least about 2 mm, at least about 2 mm, at least about 2 mm, not greater than about 20 mm, not greater than about 18 mm, not greater than about 16 mm, not greater than about 14 mm, or not greater than about 12 mm.

Item 34. The seal assembly of item 1, wherein, when the seal assembly is installed on the shaft, the lip seal is configured to stretch by not greater than about 6%, not greater than about 4%, not greater than about 3%, not greater than about 2.5%, not greater than about 2%, at least about 0.5%, at least about 1%, at least about 1.5%.

Item 35. The seal assembly of item 1, wherein the support member has a profile that defines a radius of curvature (RC) for the lip seal.

Item 36. The seal assembly of item 35, wherein the RC is at least one of uniform and symmetric.

Item 37. The seal assembly of item 35, wherein the RC is at least one of non-uniform and asymmetric.

Item 38. The seal assembly of item 35, wherein the RC is at least about 2 mm, at least about 4 mm, at least about 6 mm, at least about 8 mm, at least about 10 mm, not greater than about 20 mm, not greater than about 18 mm, not greater than about 16 mm, not greater than about 14 mm, not greater than about 12 mm.

Item 39. A seal assembly, comprising:

a housing;

a lip seal having a first lip seal portion adapted to mount to the housing, and a second lip seal portion to extend therefrom; and

a support member adapted to extend from the housing into contact with the second lip seal portion, and the support member is adapted to engage the second lip seal portion with a shaft.

Item 40. The seal assembly of item 39, wherein the housing comprises an outer housing and an inner housing, and the first lip seal portion is adapted to be located between the outer and inner housings.

Item 41. The seal assembly of item 39, wherein the support member is adapted to be spaced apart from the shaft only by a thickness (T) of the lip seal, such that there is no gap between the support member and the second lip seal portion in the radial direction.

Item 42. The seal assembly of item 39, wherein the support member has a thickness (SMT) of at least about 0.1 mm, at least about 1 mm, at least about 5 mm, at least about 10 mm, and not greater than about 20 mm, not greater than about 15 mm, not greater than about 12 mm.

Item 43. The seal assembly of item 42, wherein the SMT is at least one of uniform and symmetric.

Item 44. The seal assembly of item 42, wherein the SMT is at least one of non-uniform and asymmetric.

Item 45. The seal assembly of item 39, wherein the support member is adapted to contact the second lip seal portion over an angular span of at least about 10 degrees, at least about 20 degrees, at least about 30 degrees, at least about 40 degrees, at least about 50 degrees, not greater than about 100 degrees, not greater than about 90 degrees, not greater than about 80 degrees, not greater than about 70 degrees.

Item 46. The seal assembly of item 39, wherein the lip seal further comprises a third lip seal portion adapted to contact the shaft, and the support member is configured to contact the first, second and third lip seal portions.

Item 47. The seal assembly of item 46, wherein the first lip seal portion is configured to extend exclusively in a radial direction, the third lip seal portion is adapted to extend exclusively in an axial direction, and the second lip seal portion extends between the first and third lip seal portions.

Item 48. The seal assembly of item 46, wherein an end segment (ES) of the third lip seal portion is adapted to only contact the shaft and is free of contact with the support member.

Item 49. The seal assembly of item 46, wherein the second lip seal portion has a length (L2) and the third lip seal portion has a length (L3), and a ratio of L2/L3 is at least about 1, at least about 1.1, at least about 1.2, at least about 1.3, at least about 1.4, at least about 1.5, not greater than about 5, not greater than about 4, not greater than about 3, not greater than about 2.

Item 50. The seal assembly of item 39, wherein the support member comprises an elastomer or a metal spring element.

Item 51. The seal assembly of item 39, wherein the support member is a shock absorber.

Item 52. The seal assembly of item 39, wherein the support member is hollow.

Item 53. The seal assembly of item 39, wherein the support member is solid.

Item 54. The seal assembly of item 39, wherein the support member is formed from a single component.

Item 55. The seal assembly of item 39, wherein the support member is annular and has a D-shaped sectional profile, including a flat outer portion mounted to the housing.

Item 56. The seal assembly of item 39, wherein the support member has a density of at least about 10 kg/m³, at least about 100 kg/m³, at least about 1000 kg/m³, at least about 5000 kg/m³, and not greater than about 9000 kg/m³, not greater than about 9000 kg/m³, not greater than about 5000 kg/m³, not greater than about 1000 kg/m³, not greater than about 100 kg/m³.

Item 57. The seal assembly of item 39, wherein the support member is adapted to be bonded, mechanically joined or welded to the housing, or any combination thereof.

Item 58. The seal assembly of item 39, wherein the lip seal comprises as a fluorinated polymer, polyethylene or a mixture or copolymer thereof.

Item 59. The seal assembly of item 39, wherein the lip seal has a flat, undeflected configuration prior to installation with an inner diameter (ID) of at least about 20 cm, and not greater than about 500 cm, not greater than about 400 cm, or not greater than about 300 cm, such that the seal assembly is adapted to seal shafts having a shaft outer diameter of at least about 20 cm and not greater than about 500 cm, not greater than about 400 cm, or not greater than about 300 cm.

Item 60. The seal assembly of item 39, wherein the lip seal comprises an aspect ratio (AR) =outer diameter (OD)/inner diameter (ID) of less than about 1.15, less than about 1.12, less than about 1.09, less than about 1.06, less than about 1.03, at least about 1.01.

Item 61. The seal assembly of item 39, wherein the seal assembly has a mass of about 10 kg to about 200 kg.

Item 62. The seal assembly of item 39, further comprising a second seal member adapted to be located between the housing and the lip seal.

Item 63. The seal assembly of item 39, wherein the second seal member comprises an o-ring or a gasket.

Item 64. The seal assembly of item 39, wherein the seal assembly is adapted to seal shaft rotational speeds of at least about 10 m/s, at least about 20 m/s, at least about 30 m/s, not greater than about 50 m/s, not greater than about 45 m/s, or not greater than about 40 m/s.

Item 65. The seal assembly of item 39, wherein the seal assembly is adapted to seal the shaft with a pressure of at least about 1 bar, at least about 2 bar, at least about 4 bar, at least about 6 bar, not greater than about 10 bar, not greater than about 8 bar.

Item 66. The seal assembly of item 39, wherein the seal assembly is adapted to seal shafts having an eccentricity of rotation of at least about 0.5 mm, at least about 1 mm, at least about 1.5 mm, not greater than about 2 mm.

Item 67. The seal assembly of item 39, wherein the seal assembly is adapted to contact a shaft having an axis, and the lip seal is adapted to contact the shaft over an axial length (AL) of at least about 2 mm, at least about 2 mm, at least about 2 mm, at least about 2 mm, at least about 2 mm, not greater than about 20 mm, not greater than about 18 mm, not greater than about 16 mm, not greater than about 14 mm, or not greater than about 12 mm.

Item 68. The seal assembly of item 39, wherein, when the seal assembly is installed on the shaft, the lip seal is adapted to stretch by not greater than about 6%, not greater than about 4%, not greater than about 3%, not greater than about 2.5%, not greater than about 2%, at least about 0.5%, at least about 1%, at least about 1.5%.

Item 69. The seal assembly of item 39, wherein the support member has a profile that defines a radius of curvature (RC) for the second lip seal portion.

Item 70. The seal assembly of item 69, wherein the RC is at least one of uniform and symmetric.

Item 71. The seal assembly of item 69, wherein the RC is at least one of non-uniform and asymmetric.

Item 72. The seal assembly of item 69, wherein the RC is at least about 2 mm, at least about 4 mm, at least about 6 mm, at least about 8 mm, at least about 10 mm, not greater than about 20 mm, not greater than about 18 mm, not greater than about 16 mm, not greater than about 14 mm, not greater than about 12 mm.

Item 73. The seal assembly of item 39, wherein the support member is adapted to be positioned at least one of axially and radially adjacent the radial extension, such that at least one of an axial force and a radial force are applied thereto.

Item 74. The seal assembly of item 39, wherein at least one of the lip seal and the support member comprises a taper.

Item 75. The seal assembly of item 74, wherein the taper is linear.

Item 76. The seal assembly of item 16 or 50, wherein the elastomer comprises silicone.

Item 77. The seal assembly of item 24 or 58, wherein the fluorinated polymer comprises polytetrafluoroethylene (PTFE).

Item 78. The seal assembly of item 1 or 39, wherein the support member has a Shore A hardness of at least about 5, at least about 10, at least about 20, at least about 30, at least about 40, at least about 50, at least about 60, at least about 70, at least about 80, and not greater than about 100, not greater than about 90, not greater than about 80, not greater than about 70.

Item 79. The seal assembly of item 1 or 39, wherein the support member has a Shore D hardness of at least about 5, at least about 10, at least about 20, at least about 30, at least about 40, at least about 50, at least about 60, at least about 70, at least about 80, and not greater than about 100, not greater than about 90, not greater than about 80, not greater than about 70.

Item 80. The seal assembly of item 1 or 39, wherein the support member has a Shore OO hardness of at least about 5, at least about 10, at least about 20, at least about 30, at least about 40, at least about 50, at least about 60, at least about 70, at least about 80, and not greater than about 100, not greater than about 90, not greater than about 80, not greater than about 70.

Item 81. The seal assembly of item 1 or 39, wherein the support member has a Vickers hardness of at least about 50, at least about 100, at least about 200, at least about 500, at least about 750, at least about 1000, at least about 1250, at least about 1500, and not greater than about 2000, not greater than about 1900, not greater than about 1800, not greater than about 1700.

Item 82. The seal assembly of item 1 or 39, wherein the support member has a spring constant of at least about 0.1 N/m, at least about 1 N/m, at least about 10 N/m, at least about 100 N/m, at least about 1000 N/m, at least about 10,000 N/m, and not greater than about 100,000 N/m, not greater than about 75,000 N/m, not greater than about 50,000 N/m.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A seal assembly, comprising:
a lip seal that is annular and has an axis, a central opening and a radial extension extending radially inward, the radial extension being flexible and adapted to apply a sealing force against a shaft extending through the central opening by bending, such that the radial extension extends at least partially along an axial direction; and
a support member that is resilient and configured to be positioned adjacent the radial extension such that the support member limits bending of the radial extension.

2. The seal assembly of claim 1, wherein the support member is configured to be positioned at least one of axially and radially adjacent the radial extension upon disposition of the shaft, such that at least one of an axial force and a radial force are applied thereto.

3. The seal assembly of claim 1, wherein at least one of the lip seal and the support member comprises a taper.

4. (canceled)

5. The seal assembly of claim 1, further comprising a housing, and the lip seal and the support member are adapted to be mounted to the housing.

6. The seal assembly of claim 5, wherein the housing comprises an outer housing and an inner housing, and the lip seal is configured to be located between the outer and inner housings.

7. (canceled)

8. The seal assembly of claim 1, wherein the support member is configured to be spaced apart from the shaft only by a thickness (T) of the lip seal, such that there is no gap between the support member and the second lip seal portion in the radial direction upon disposition of the shaft.

9. The seal assembly of claim 1, wherein the support member has a thickness (SMT) of at least about 0.1 mm, and not greater than about 20 mm.

10.-12. (canceled)

13. The seal assembly of claim 1, wherein the lip seal comprises a first lip seal portion that is configured to extend exclusively in a radial direction, a third lip seal portion that is configured to extend exclusively in an axial direction in contact with the shaft, and a second lip seal portion that extends between the first and third lip seal portions.

14. (canceled)

15. The seal assembly of claim 1, wherein an end segment (ES) of the lip seal is configured to contact only the shaft and is free of contact with the support member.

16.-21. (canceled)

22. The seal assembly of claim 1, wherein the support member has a density of at least about 10 kg/m³, and not greater than about 9000 kg/m³.

23.-25. (canceled)

26. The seal assembly of claim 1, wherein the lip seal comprises an aspect ratio (AR)=outer diameter (OD)/inner diameter (ID) of less than about 1.15, and at least about 1.01.

27.-29. (canceled)

30. The seal assembly of claim 1, wherein the seal assembly is configured to seal shaft rotational speeds of at least about 10 m/s, and not greater than about 50 m/s.

31. The seal assembly of claim 1, wherein the seal assembly is configured to seal the shaft with a pressure of at least about 1 bar, and not greater than about 10 bar.

32. The seal assembly of claim 1, wherein the seal assembly is configured to seal an eccentricity of rotation of the shaft of at least about 0.5 mm, and not greater than about 2 mm.

33. (canceled)

34. The seal assembly of claim 1, wherein, when the seal assembly is installed on the shaft, the lip seal is configured to stretch by not greater than about 6%, and at least about 0.5%.

35.-38. (canceled)

39. A seal assembly, comprising:
a housing;
a lip seal having a first lip seal portion adapted to mount to the housing, and a second lip seal portion to extend therefrom; and
a support member adapted to extend from the housing into contact with the second lip seal portion, and the support member is adapted to engage the second lip seal portion with a shaft.

40.-60. (canceled)

61. The seal assembly of claim 39, wherein the seal assembly has a mass of about 10 kg to about 200 kg.

62.-77. (canceled)

78. The seal assembly of claim 1, wherein the support member has a Shore A hardness of at least about 5, and not greater than about 100.

79.-80. (canceled)

81. The seal assembly of claim 1, wherein the support member has a Vickers hardness of at least about 50, and not greater than about 2000.

82. The seal assembly of claim 1, wherein the support member has a spring constant of at least about 0.1 N/m, and not greater than about 100,000 N/m.
